(19) United States
(12) Patent Application Publication
(10) Pub. No.: US 2007/0017778 A1
(43) Pub. Date: Jan. 25, 2007

(54) Conveyor system

(76) Inventors: Paul Skljarow, Schwieberdingen (DE); Delf Reumann, Stuttgart (DE); Boris Buesing, Stuttgart (DE); Peter Ludwig, Tuebingen (DE)

Correspondence Address: STRIKER, STRIKER & STENBY, 103 EAST NECK ROAD, HUNTINGTON, NY, 11743, US

(21) Appl. No.: 11/489,136

(22) Filed: Jul. 19, 2006

(30) Foreign Application Priority Data
Jul. 20, 2005 (DE) 10 2005 033 947.6

(51) Int. Cl. B65G 47/46

(52) U.S. Cl. 198/367.1

(57) ABSTRACT

A conveyor system has a conveyor track with a conveyor means that moves along at least one subsection of the conveyor track in a direction of conveyance, at least one workpiece carrier bringable into driving engagement with the conveying means to move it in the direction of conveyance, and a deflection device that deflects the workpiece carrier out of the direction of conveyance and therefore moves it from the subsection of the conveyor track, the deflection device including a deflection section that swivels the workpiece carrier around a swivel axis that is substantially parallel to its vertical axis, the deflection device also including a further deflection section that is located along a trajectory of the workpiece carrier in front of the deflection section and has a different design than the deflection section and that displaces the workpiece carrier laterally relative to the subsection of the conveyor track.

### CROSS-REFERENCE TO A RELATED APPLIACTION

The invention described and claimed hereinbelow is also described in German Patent Application DE 10 2005 033 947.6 filed on Jul. 20, 2005. This German Patent Application, whose subject matter is incorporated here by reference, provides the basis for a claim of priority of invention under 35 U.S.C. 119(a)-(d).

### BACKGROUND OF THE INVENTION

The present invention relates generally to conveyor systems. More particularly, the present invention relates to a conveyor system that includes a conveyor track with a conveying means that moves along at least a subsection of the conveyor track in a direction of conveyance, and at least one workpiece carrier that is capable of being brought into driving engagement with the conveying means to be moved in the direction of conveyance, and a deflection device that deflects the workpiece carrier out of the direction of conveyance and therefore removes it from the subsection of the conveyor track, the deflection device including a deflection section that swivels the workpiece carrier around a swivel axis that is essentially parallel to its vertical axis.

The term “conveying means” as used in the context of the present invention can refer, e.g., to a conveyor track, a conveyor belt, a belt of a conveyor, a chain conveyor, or the like. The conveying system according to the present invention can be used, e.g., to convey workpiece carriers on an assembly line from one processing station to another. The term “workpiece carrier” also refers to conveyed item carriers in general, that is, e.g., carriers that convey goods that are not processed at a station on the conveyor track or that are used to process another component, but that are only transported to one station on the conveyor track, e.g., where the goods will be packaged or stored.

One problem that is always associated with generic conveyor systems is how to move the workpiece carriers along subsections of the conveyor track that are not straight, e.g., to turn around a 90° corner or to transition from a main route of the conveyor track to, e.g., a secondary route of the conveyor track that extends in parallel with the main route of the conveyor track. With the conveyor system made known in GB 2 303 601 A, the workpiece carrier includes, to this end, two downwardly-projecting pins that engage in a guide rail with two lateral guide surfaces. It has been proven in practice, however, that this type of guidance of the workpiece carriers very easily results in the pins tilting in the guide rails and, therefore, to blockage of the movement of the workpiece carriers. A further disadvantage of this related art is the fact that small parts, e.g., small screws, dirt particles or the like can enter the guide rails and thereby block the movement of the workpiece carrier.

The same applies for the conveyor systems made known in DE 88 13 730 U1, EP 0 417 041 A1, EP 0 527 689 B1 and EP 0 997 402 A2.

### SUMMARY OF THE INVENTION

It is therefore the object of the present invention to provide a conveyor system of the type described initially that is less susceptible to becoming blocked.

This object is achieved according to the present invention via a conveying system of the type mentioned initially, with which the deflection device also includes a further deflection section that is located along the trajectory of the workpiece carrier in front of a deflection section that has a different design than the other deflection section, and that displaces the workpiece carrier laterally relative to the subsection of the conveyor track.

As a result of this lateral displacement, the lever arm with which the conveying means is swiveled in the deflection section in which the workpiece carrier is swiveled and which grips the workpiece carrier is lengthened. As a result, the torque that is available for swiveling the workpiece carrier increases - as compared with a case without a lateral displacement of this type - while the, e.g., frictional engagement force between the conveying means and the workpiece carrier remains the same. This increase in torque results in the desired reduction in susceptibility to blockage. The present invention is therefore based on the finding that the increased susceptibility to blockage of the conveyor systems known from the aforementioned related art is based on the fact that, in those cases, the deflection sections are defined exclusively by guide tracks bent in the shape of a circular arc and that tangentially abut the incoming and outgoing subsections of the conveyor track.

To ensure that the aforementioned large swivelling lever arm is available for the duration of the swiveling of the workpiece carrier in the one deflection section, it is provided that a third deflection section be provided that is located along the trajectory of the workpiece carrier after the deflection section that has a different design than the other deflection section, the third deflection section laterally displacing the workpiece carrier preferably relative to a subsection of a further conveyor track.

As known per se from the related art, with the present invention, the one deflection section, i.e., the swivel section, can also include at least one subsection that is curved according to a predetermined radius of curvature.

According to the present invention, the further deflection section and/or the third deflection section can include at least one subsection, the radius of curvature of which is greater than the radius of curvature of the at least one subsection of the one deflection section.

The at least one subsection can be designed to be curved or to extend in a straight line, because a straight shape is understood to mean, in conjunction with the present invention, a curved shape with an endlessly large radius of curvature.

Furthermore, the further deflection section or/and the third deflection section includes at least one further subsection, the radius of curvature of which is smaller than the radius of curvature of the at least one subsection of the further deflection section or/and the third deflection section, the further subsection preferably being shorter than the other subsection. The further subsection of the further deflection section or/and the third deflection section can be located on the end of the one subsection of the further deflection section or/and the third deflection section opposite to the one deflection section.

As a result, the trajectory in the further deflection section and/or the third deflection section as viewed starting at the conveyor track can be brought relatively quickly into a large angle relative to the direction of conveyance of the conveyor track, which ensures an adequate lateral displacement of the workpiece carrier despite the relatively small amount of installation space required. In the larger radius of curvature in the subsection, the risk of blockage can be reduced by its shorter length. As the course proceeds, work can be carried out in the subsection with a larger radius of curvature that is more favorable in terms of the risk of blockage.

Depending on the application, the free end of the further deflection section or/and the third deflection section can extend essentially parallel to the direction of conveyance of the further conveyor track. It is also possible, as an alternative, however, that the free end of the further deflection section or/and the third deflection section forms a predetermined angle with the conveying device of the further conveyor track.

The latter alternative can be used, e.g., when the further deflection section or/and the third deflection section is designed essentially straight in shape.

Although the further deflection section or/and the third deflection section as described above serve to deflect the workpiece carrier laterally off of the guide track, it is also possible for the workpiece carrier to also be deflected inwardly or pre-swiveled slightly in the further deflection section or/and the third deflection section.

If the deflection device is used to transfer a workpiece carrier from a main conveyance path to a secondary conveyance path that extends essentially parallel thereto, a deflection section extension that is deflectable in a resilient manner can be located on the free end of the third deflection section. This is advantageous because, as a result, the guidance of the workpiece carrier can be improved in the region of the transition from the deflection device assigned to the main conveyance path to the deflection device assigned to the secondary conveyance path. It has been proven, however, that this deflection section extention is in the way of the workpiece carrier when the workpiece carrier is swiveled onto the secondary conveyance path. This problem is circumvented, however, by the fact that the deflection section extension can be deflected in a resilient manner. This ability to be deflected in a resilient manner can be realized either via an inherent elasticity of the deflection section extension or by designing the deflection section extension as a separate part that is pivotably supported against spring preload.

To realize a switch function, it is further provided that a free end of the further deflection section is displaceable in a direction that extends essentially transversely to the subsection of the conveyor track. The further deflection section can be elastically deformable or it can be connected with one deflection section via an elastically deformable joint section. According to another alternative, the at least one part of the further deflection section can be designed as a rigid yet pivotable unit.

According to a further aspect of the present invention, for which independent protection is desired, the susceptibility to blockage of the workpiece carrier can also be reduced—in addition to or as an alternative to the lateral displacement of the workpiece carrier discussed above, the purpose of which is to increase the length of the swivelling lever arm—by providing the deflection device with a deflection strip that is in deflection engagement with a guide unit of the workpiece carrier on the side facing away from the workpiece carrier and with a guide surface of the workpiece carrier on the side facing the workpiece carrier. The inventors have recognized that, with the conveyor systems known from the aforementioned related art, the susceptibility to blockage is due mainly to the fact that, in those cases, the guide unit of the workpiece carrier engages in a guide rail with two lateral guide surfaces.

In a particularly preferred refinement of this second aspect of the present invention it is provided that the guide unit includes just one guide element that is located—preferably in a stationary manner—on the workpiece carrier. This sole guide element can be provided with means that reduce kinetic friction. For example, the guide element can be provided with a coating that reduces kinetic friction, or it can include a roller supported via a rolling bearing or a plain bearing.

It is also possible, as an alternative, for the guide unit to include two guide elements that have at least two degrees of freedom of movement relative to the workpiece carrier. The two guide elements can also be provided with means that reduce kinetic friction. For example, the guide elements can be provided with a coating that reduces kinetic friction, or it can include a roller supported via a rolling bearing or a plain bearing. The two degrees of freedom of movement of these two guide elements can be realized, e.g., by the fact that the two guide elements are located such that they are displaceable independently of each other and relative to the workpiece carrier. It is also possible, however, to locate the two guide elements on the same rocker that is capable of being swiveled around the vertical axis of the workpiece carrier and that is displaceable relative to the workpiece carrier essentially in its transverse direction. According to both variations, the displacement can preferably take place against spring preload.

To reduce the risk that the guide unit will block the movement of the workpiece carrier along the conveyor track, it is preferrable for the guide unit to be located within the peripheral contour of the workpiece carrier.

It is also advantageous to the engagement with the deflection device when the guide unit is located adjacent to an edge of the workpiece carrier. Preferably, one guide surface and one guide unit each are even assigned to both edges of the workpiece carrier. To make it easier for the guide unit and deflection device to engage and disengage, it is provided in a refinement of the present invention for the guide surface or each of the guide surfaces to include an orientation bevel on its end section of the workpiece carrier at the front relative to the direction of motion and, possibly, also on its rear end section.

It can also be provided that the workpiece carrier has a rectangular base; the ratio of the length of the shorter transverse side to the length of the longer longitudinal side of the rectangle is between approximately 1.2 and approximately 1.5, and more preferably approximately 1.33. This makes it possible for even untrained personnel to easily identify the longitudinal direction of the workpiece carrier. As a result, the conveying engagement between the conveying means and the workpiece carrier—which is important in terms of moving the workpiece carrier—is maintained for a longer period of time even when deflection occurs. If the purely rectangular shape in one or the other applications proves to be obstructive due to its length, e.g., due to the risk of collisions with parts of the deflection device, the workpiece carrier can have rounded corners and/or be designed basically square in shape.

In addition, to reduce the susceptibility to blockage, it can also be provided that at least one deflection section, preferably at least the further deflection section, the deflection device and/or the guide surface of the workpiece carrier are provided with means that reduce the kinetic friction. This can be realized by providing a kinetic friction-reducing coating on the guide surface of the workpiece carrier or the surface of the deflection strip of the at least one deflection section that faces the guide surface of the workpiece carrier, and by providing at least one roller element on the side of the deflection strip that faces the workpiece carrier.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a schematic top view of a conveying system according to the present invention;

FIG. 2a shows a top view of the deflection device of the conveyor system in FIG. 1;

FIG. 2b shows a perspective view of the deflection device in FIG. 2a;

FIGS. 3a and 3b show an underside view (FIG. 3a) and a side view (FIG. 3b) of the workpiece carrier used with the conveyor system in FIG. 1;

FIG. 4 shows a view similar to FIG. 1 of a further use of the conveying system according to the present invention;

FIG. 5 shows a perspective view of the deflection device used in the conveyor system depicted in FIG. 4;

FIG. 6 shows a view similar to FIG. 2a of a modified embodiment of a 90° deflection device;

FIG. 7 shows a further modified embodiment of a 90° deflection device that is similar to the deflection device depicted in FIG. 6 but which differs therefrom by the fact that it also has a switch function;

FIG. 8 shows a view similar to FIG. 4 of a deflection device for transferring workpiece carriers from the main conveyance path to a secondary conveyance path;

FIG. 9 shows an enlarged view of a part of the deflection device in FIG. 8;

FIGS. 10 and 11 show partial views of two modified workpiece carriers;

FIG. 12 shows a view similar to FIG. 1 that explains the use of workpiece carriers in FIGS. 10 and 11; and

FIG. 13 shows a view similar to FIG. 2a of a 90° deflection device used with the embodiment in FIG. 12.

### DESCRIPTION OF THE PREFERRED EMBODIMENTS

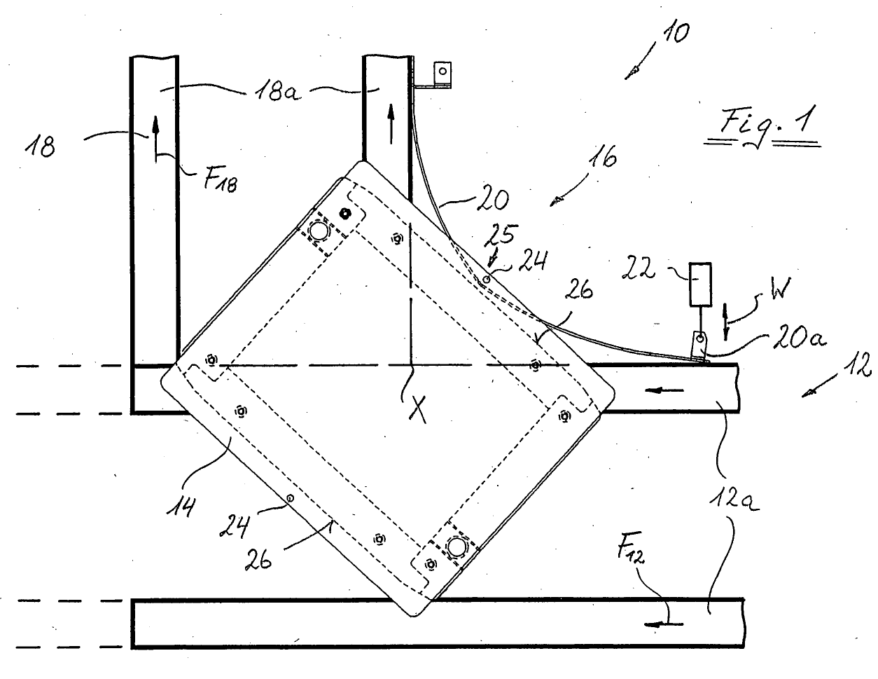

A conveying system according to the present invention is labelled in general with reference numeral 10 in FIG. 1. It includes an incoming conveyor track 12, along which workpiece carriers 14 are conveyed from the right as shown in FIG. 1. Furthermore, a deflecting device 16 is provided that deflects workpiece carriers 14 from incoming conveyor track 12 to an outgoing conveyor track 18.

Incoming conveyor track 12 includes two drive belts 12a driven by a not-shown drive unit, and outgoing conveyor track 18 includes two drive belts 18a that are also driven by a not-shown drive unit. For simplicity, the deflection rollers are not shown in the depiction in FIG. 1, around each of which the ends of endless conveyor belts 12a, 18a shown in FIG. 1 are redirected, so that they return to the other end—which is not shown in FIG. 1—of the two conveyor belts 12 and 18.

In FIG. 1, incoming conveyor track 12 and outgoing conveyor track 18 are parts of a main conveying track that, at the point shown in FIG. 1, forms a 90° curve or a 90° angle to the right. It is also basically possible that conveyor track 12 is part of the main conveying track that continues to the left in FIG. 1—which is indicated via dashed lines—and that conveyor track 18 is part of a secondary conveyance path, onto which at least some of workpiece carriers 14 are transferred.

In the first case, deflection device 16—which includes a deflection strip in the embodiment according to FIG. 1—can be designed as a rigid, non-adjustable deflection device, while, in the second case, it is preferably designed as a switch, and the free end 20a of deflection strip 20 can be selectively brought into or out of deflection engagement with workpiece carriers 14. This is indicated in FIG. 1 by a schematically illustrated actuating device 22 that can selectively move free end 20a of deflection strip 20 away from or toward conveyor track 12, which is indicated in FIG. 1 with double arrow W.

As shown in FIG. 1 and illustrated in greater detail in FIGS. 3a and 3b, workpiece carrier 14 includes two support segments 14b that extend in longitudinal direction L of workpiece carrier 14 on its lower surface 14a, with which workpiece carrier 14 is supported when transported in a straight line along conveyor tracks 12, 18 on conveyor belts 12a, 18a. Workpiece carrier 14 also includes support segments 14c that extend in transverse direction Q of workpiece carrier 14 and engage with conveyor belts 12a, 18a after workpiece carrier 14 makes a deflected motion from an incoming conveyor track 12 onto an outgoing conveyor track 18.

Furthermore, workpiece carrier 14 includes an engagement pin 24 next to its lateral surface 14d, approximately in the region of the transverse center line of workpiece carrier 14, and a guide surface 26 that extends essentially in longitudinal direction L of workpiece carrier 14. Guide pin 24 projects downwardly from workpiece carrier 14 in vertical direction H of workpiece carrier 14 and is rigidly located thereon. Guide surface 26 includes orientation bevels 26a and 26b on its ends that adjoin front and back end faces 14e, 14f.

As shown in FIG. 1, deflection strip 20 extends between guide pin 24 and guide surface 26 of workpiece carrier 14.

In addition, workpiece carrier 14—with the exception of recesses 28 that 10 serve as passages for the engagement elements of the separating devices—is designed symmetrical with respect to longitudinal center axis ML and therefore has a total of two guide pins 24 and two guide surfaces 26. As a result, workpiece carrier 14 can be turned 180° on the conveyance path, so that both sides of a workpiece conveyed thereon are easily accessible for processing from either side of the conveyance path. In addition, the operating personnel need not pay attention to which of the two end faces 14e, 14f is the front end face and which is the rear end face. It is also possible to bring workpiece carrier 14 into deflection engagement with a deflection device 16 located on the left side of guide track 12, 18 and to therefore deflect it to the left off of the guide track. It is also possible to bring workpiece carrier 14 into deflection engagement with a deflection device 16 located on the right side of the guide track and to therefore deflect it to the right off of the guide track.

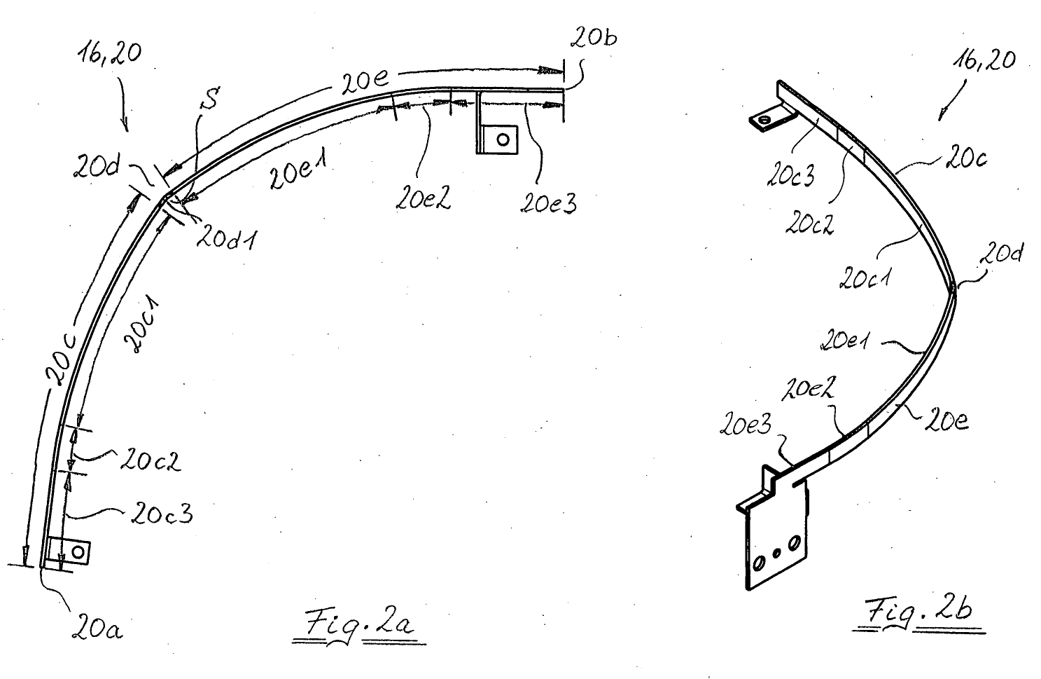

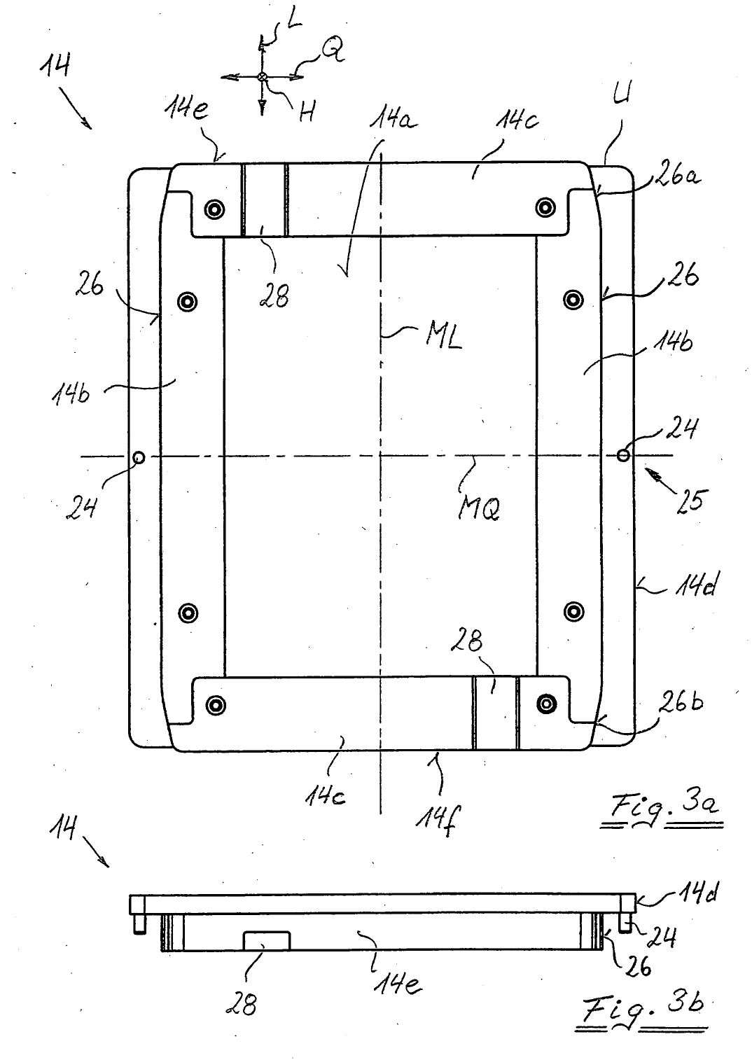

As shown in FIGS. 2a and 2b, deflection strip 20 of deflection device 16 is subdivided into a large number of deflection sections 20c, 20d and 20e between its two ends 20a and 20b. The actual swiveling of workpiece carrier 14 off of conveyor track 12 and onto conveyor track 18 takes place in the center deflection section 20d, the inner surface 20d1 of which that engages with guide pin 24 has a radius of curvature that is only slightly larger than the radius of guide pin 24 and which is preferably no more than double the radius of guide pin 24. In contrast, deflection sections 20c and 20e serve to laterally displace workpiece carrier 14 at the beginning and toward the end of the transfer from incoming conveyor track 12 to outgoing conveyor track 18, so that swivel axis S—which is defined essentially by center deflection section 20d—can be located as far away as possible from intersection X of the two conveyor tracks 12 and 18.

The two outer deflection sections 20c and 20e are also designed curved in shape; their radius of curvature is greater than that of center deflection section 20d. More specifically, the two outer deflection sections 20c and 20e each includes three deflection subsections 20c1, 20c2 and 20c3 or 20e1, 20e2 and 20e3, namely, a first deflection subsection 20c1 or 20e1 having a longer length and a greater radius of curvature, and, adjacent thereto, a second deflection subsection 20c2 or 20e2 having a shorter length and smaller radius of curvature—both deflection subsections starting at center deflection section 20d. Finally, a straight deflection subsection 20c3 or 20e3 abuts ends 20a and 20b, i.e., it is a deflection subsection with an infinitely large radius of curvature.

Although deflection subsection 20c1 in the embodiment according to FIG. 2a has a different radius of curvature and a different length than deflection subsection 20e1—and the same applies for deflection subsections 20c2 and 20e2—it is also possible for these deflection subsections—considered in pairs—to have identical configurations.

The two terminal deflection subsections 20c3 and 20e3 serve mainly only to establish the deflection engagement between guide pin 24 and guide surface 26 of workpiece carrier 14, and with deflection strip 22 of deflection device 16. The short, relatively sharply curved deflection subsections 20c2 and 20e2 ensure that the deflection angle—relative to the forward motion of workpiece carrier—that is important for the lateral displacement reaches a relatively high value relatively quickly, since this allows a marked lateral deflection and, therefore, a marked lengthening of the swivelling lever to be attained, even when the length of deflection strip 20 is short.

The relatively weak curvature of deflection subsections 20c1 and 20e1 that abut swivel section 20d serve only to ensure that the size of the contact areas and, therefore, the resultant kinetic friction between guide carriage 14—its guide surface 26 in particular—and deflection strip 20 can be kept low, and that the distance between these contact areas can be large, which is also advantageous in terms of reducing the susceptibility of workpiece carrier 14 to blockage.

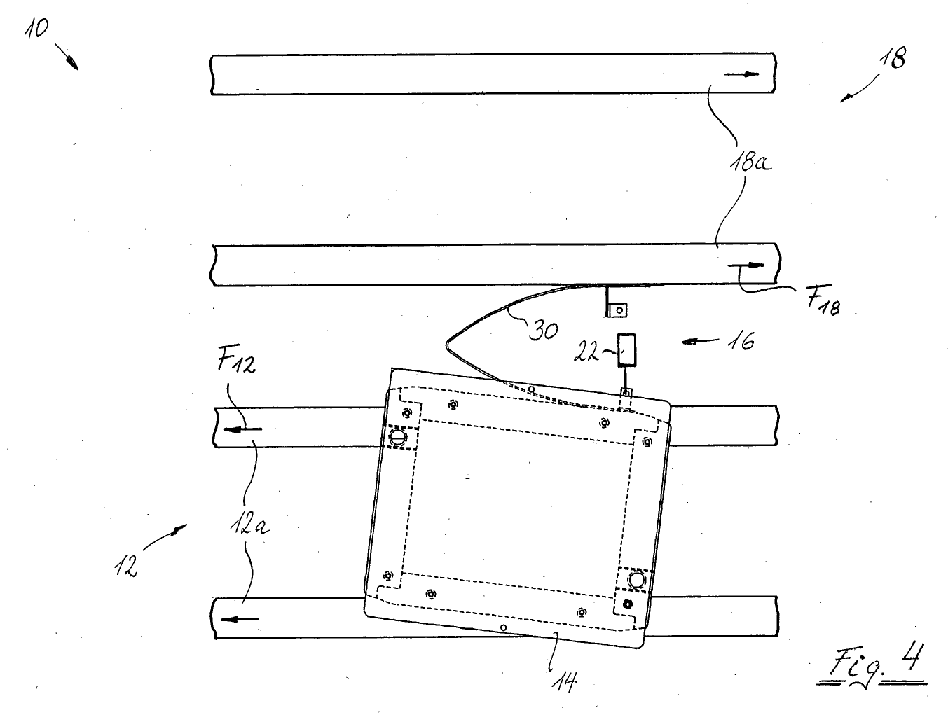

A further application of a conveyor system 10 according to the present invention is shown in FIG. 4. With this application, deflection device 16 serves to transfer a workpiece carrier 14 from conveyor track 12, which is part of a main conveyance path, onto a conveyor track 18 that is part of a secondary conveyance track.

In the application according to the present invention, deflection strip 30 of deflection device 16 serves to redirect workpiece carrier 14 by 180°—relative to direction of conveyance F₁₂ of conveyor track 12—to conveyor track 18 that is moving in the opposite direction F₁₈. With the aid of an actuating device 22, deflection device 16 can be configured as a switch device.

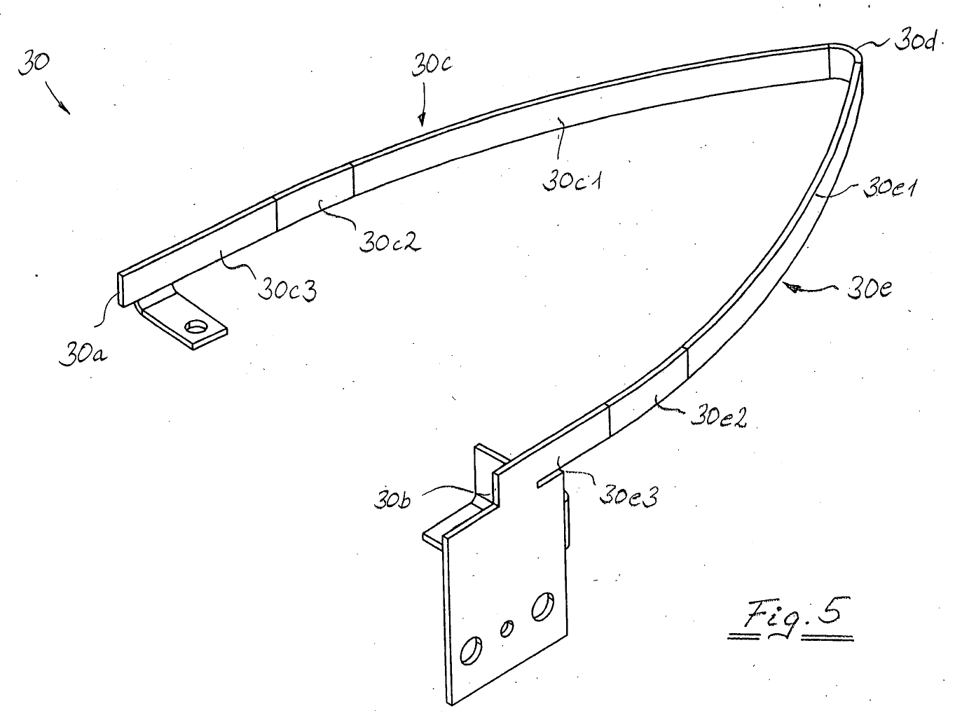

A 180° deflection strip 30 of this type is shown in a perspective illustration in FIG. 5. Its design conforms essentially to that of 90° deflection strip 20 according to FIGS. 2a and 2b, and differs from them only by the fact that curved swivel section 30d extends over a larger angular range. With regard for the design of deflection strip 30 between its free ends 30a and 30b, i.e., in particular with regard for the design of deflection sections 30c, 30d and 30e, and their subsections 30c1, 30c2, 30c3 or 30e1, 30e2, 30e3, reference is made otherwise to the description of the corresponding parts of 90° deflection strip 20.

A further embodiment of a deflection device 16 according to the present invention is shown in FIG. 6, namely a 90° deflection element 40. In contrast to deflection strip 20 shown in FIGS. 2a and 2b, deflection element 40 is rigid in design. It includes a main body 42 and a deflection strip 44 fastened to this main body or configured integrally therewith. A further difference from the embodiment according to FIGS. 2a and 2b is the fact that the two outer deflection sections 44c and 44e are straight across their entire length, i.e., they have an infinitely large radius of curvature, and they form an angle a with directions of conveyance F₁₂ and F₁₈. With regard for the design of swivel section 44d, the embodiment according to FIG. 6 corresponds to the embodiment according to FIGS. 2a and 2b.

Due to the straight shape of outer deflection sections 44c and 44e, the entire surface of workpiece carrier according to FIGS. 3a and 3b abuts deflection strip 44 with its guide surface 26. There is a risk, therefore, of a relatively high amount of friction between workpiece carrier 14 and deflection strip 44. Rollers 46 that are adjacent to free ends 44a and 44b and swivel section 44d are therefore provided in the embodiment according to FIG. 6, off of which guide surface 26 of workpiece carrier 14 can roll in a low-friction manner. In addition to, or as an alternative thereto, guide surface 26 or/and the surface of deflection strip 44 facing it can be provided with a friction-reducing coating.

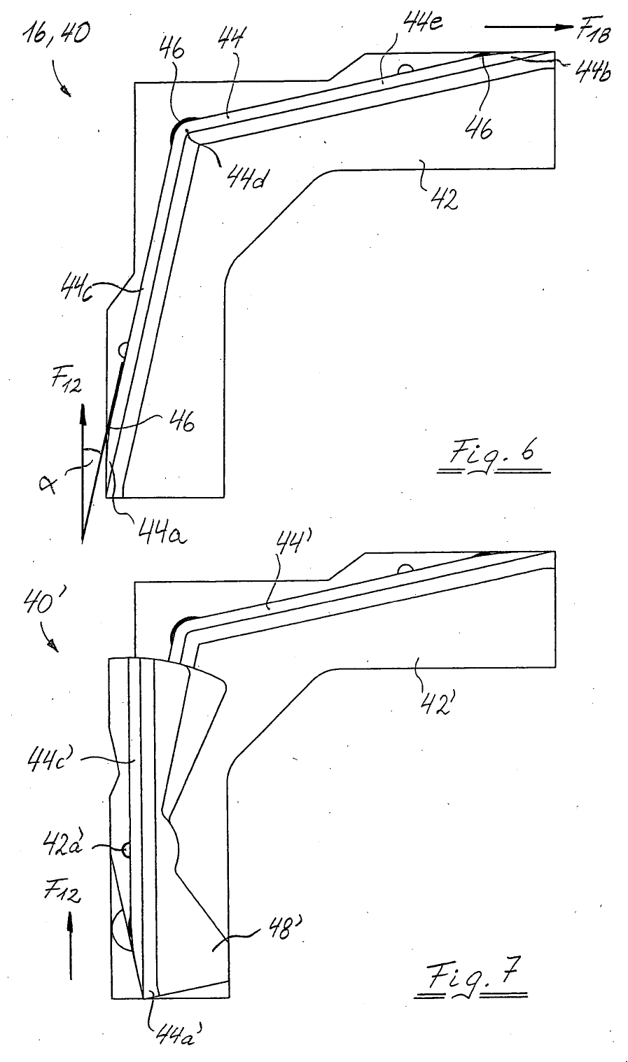

Due to the rigid design of the embodiment according to FIG. 6, a switch function cannot be provided simply by bending deflection strip 44, as was possible with the embodiment according to FIGS. 2a and 2b. Deflection element 40′ according to FIG. 7 therefore includes a swivel element 48′ that retained on base part 42′ such that it can swivel around axis 42a′ of base part 42′. At least a part of deflection section 44c′ of deflection strip 44′ is formed on swivel part 48′. The switch is deactivated in the position shown in FIG. 7, i.e., guide pin 24 of a workpiece carrier 14 moving in direction of conveyance F₁₂ does not enter into guide or deflection engagement with free end 44a′, and workpiece carrier 14 continues to move in direction of conveyance F₁₂. If swivel element 48′ is swiveled around swivel axis 42a′ in the clockwise direction using a servo unit (which is not shown in FIG. 7), however, a 90° deflection device is obtained, the function of which corresponds to that depicted in FIG. 6.

An embodiment of conveyor system 10 according to the present invention is shown in FIG. 8, with which workpiece carrier 14 can be transferred from a conveyor track 12 of a main conveyance path to a conveyance track 18—that is moving in the opposite direction—of a secondary conveyance path. To this end, a deflection element 50 is assigned to conveyor track 12 that redirects workpiece carriers 14 from direction of conveyance F₁₂ by a predetermined angle, e.g., 60°, in the direction toward conveyor track 18, and a deflection element 60 is assigned to conveyor track 18 that swivels workpiece carriers 14 in the opposite direction, so that they ultimately move on conveyor track 18 back in their direction of conveyance F₁₈.

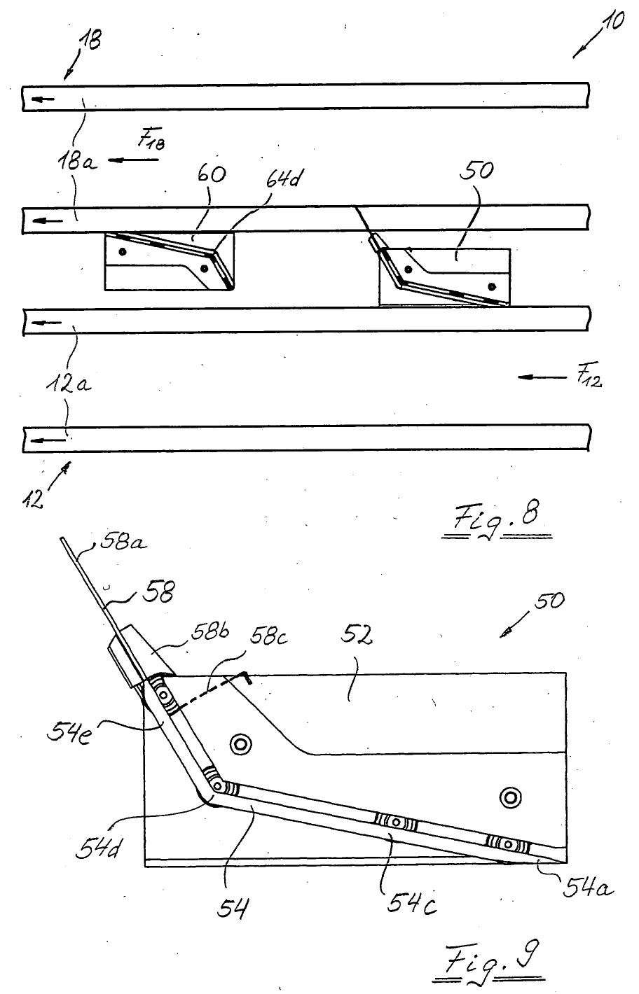

Comparing FIGS. 6 and 9 reveals that the design of deflection element 50 used in the embodiment according to FIG. 8 essentially conforms to that of deflection element 40, i.e., it has a base part 52, on which a deflection strip 54 is rigidly connected or with which it is integrally formed. Deflection section 54c, which leads in a straight line to swivel section 54d and abuts free end 54a of deflection strip 54, is essentially just as long as the deflection section according to FIG. 6. In contrast to this embodiment, however, section 54e of deflection strip 54 that abuts swivel section 54d is shorter than the corresponding deflection section of deflection element 40 shown in FIG. 6.

Deflection element 60 has the same design as deflection element 50, but the deflection sections of deflection element 60 extend from guide pin 24 of workpiece carrier 14 in the opposite direction. A further difference between deflection elements 50 and 60 is the fact that a deflection section extension 58 is also provided on deflection element 50 that is pivotably supported on base part 52. Deflection section extension 58 includes extension blade 58a itself, its holder 58b, and a torsion spring 58c the preloads holder 58b in the position shown in FIG. 9.

When a workpiece carrier 14 moves under the influence of the guide engagement of its guide pin 24 with deflection strip 54 of deflection element 50 away from guide track 12, and when its other guide pin 24 engages with deflection element 60, deflection section extension 58 ensures that workpiece carrier 14 continues to moves in a straight line in the transition region between the two deflection elements 50 and 60 in the manner desired. When guide pin 24 of workpiece carrier 14 then engages with swivel section 64d of deflection element 60, however, and workpiece carrier 14 is swiveled back onto conveyor track 18, deflection section extension 58 of deflection element 50 is in the way of rear end of workpiece carrier 14. This is not a problem, however, since the rear end of workpiece carrier 14 can deflect deflection section extension 58 due to its pivotable attachment to base part 52 of deflection element 50.

With the embodiment of workpiece carrier 14 shown in FIGS. 1, 3a, 3b and 4, workpiece carrier 14 included guide surface 26 and a guide unit 25 that was defined by a single guide pin 24 that was rigidly located on workpiece carrier 14 within circumferential contour U of workpiece carrier 14.

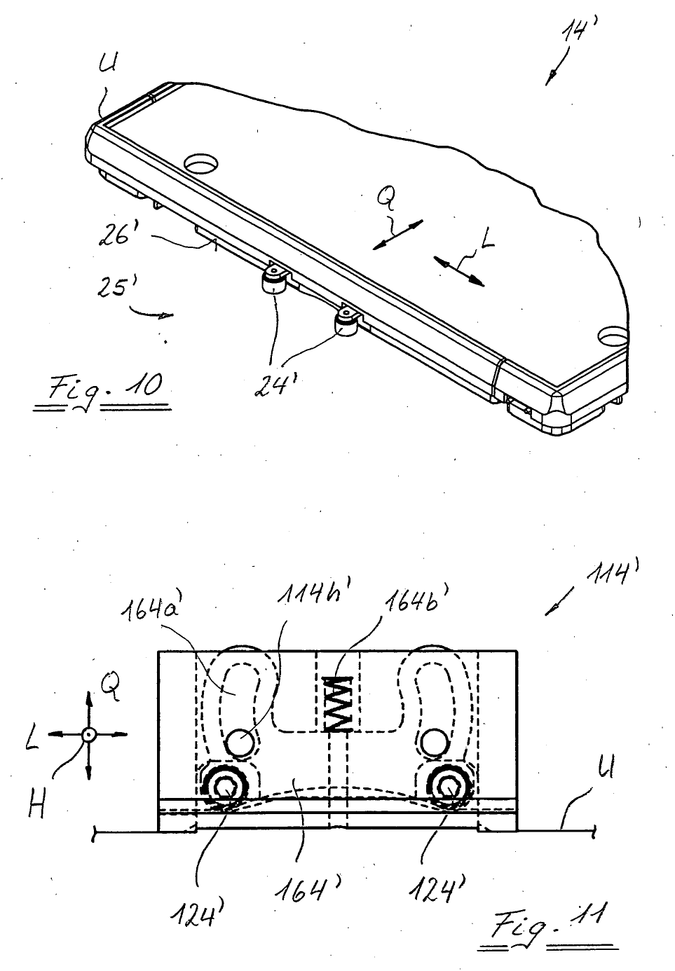

An alternative embodiment of a workpiece carrier 14′ is shown in FIG. 10, in the case of which guide unit 25′ includes guide surface 26′ and two guide rollers 24′ that are mounted such that they are displaceable independently of each other in transverse direction Q of workpiece carrier 14′. Preferably, a not-shown compression spring is assigned to each of the guide rollers that preloads its guide roller 24′ toward the outside of circumferential contour U of workpiece carrier 14.

As described above, the two guide rollers 24′ together have two degrees of freedom of movement relative to workpiece carrier 14′. As a result, if there were a risk that workpiece carrier 14′ would be blocked if guide rollers were rigidly positioned, they can then react to this risk of blockage and counteract it by making a motion relative to workpiece carrier 14′.

A further embodiment of a workpiece carrier is shown in FIG. 11 that essentially corresponds to workpiece carrier 14′ according to FIG. 10. For this reason, components shown in FIG. 11 that are identical to components in FIG. 10 are assigned the same reference numbers, but increased by 100. In addition, the description of workpiece carrier 114′ according to FIG. 11 presented below will be limited to the differences from workpiece carrier 14′ according to FIG. 10.

With workpiece carrier 114′ according to FIG. 11, the two guide rollers 124′ are mounted on workpiece carrier 114′ not independently of each other. Instead, they are rotatably mounted on a common carrier 164′ that is displaceable in workpiece carrier 114′ in its transverse direction Q and around an axis that is parallel to its vertical axis H. To this end, guide pins 114h′ of workpiece carrier 114′ engage in slots 164a′ of rocker 164′. Furthermore, a helical compression spring 164b′ is provided that preloads the rocker toward the outside of circumferential contour U of workpiece carrier 114′.

Due to the ways that rocker 164′ can move relative to workpiece carrier 114′, the two guide rollers 124′ therefore have two degrees of freedom of movement relative to workpiece carrier 114′ that enable them to react to the possibility that workpiece carrier 114′ will be blocked.

In addition, the workpiece carrier shown in FIG. 11 is shown only in the region of the seat of rocker 164′ and it can otherwise have the same design as workpiece carrier 14′ shown in FIGS. 10 and 14, and according to FIGS. 1, 3a, 3b and 4.

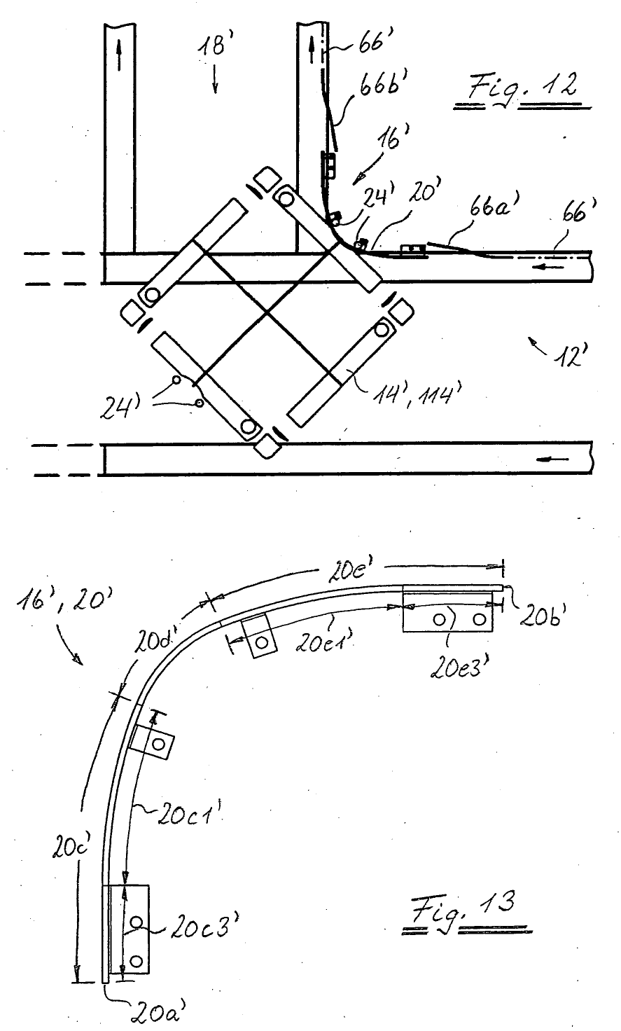

The deflection of a workpiece carrier 14′, 114′ according to FIGS. 10 and 11 will be described in greater detail with reference to FIGS. 12 and 13, which essentially correspond to FIGS. 1 and 2a. Reference is hereby made to the entire description of FIGS. 1 and 2a, and it should be noted that the description of FIGS. 12 and 13 below is limited to their differences from FIGS. 1 and 2a.

In an adaptation to the design of workpiece carrier 14′, 114′ with two guide rollers 24′, 124′ located at a distance from the workpiece carrier in longitudinal direction L, deflection strip 20′ of deflection device 16′ differs from deflection strip 20 mainly by the fact that swivel section 20d′ is longer than corresponding swivel section 20d of deflection strip 20. In addition, the two outer deflection sections 20c′ and 20e′ are subdivided only into two deflection subsections 20c1′, 20c3′ or 20e1′, 20e3′.

Although this is indicated in FIG. 12 via a dashed line on each of the edges of guide tracks 12′, the two guide tracks are provided with guide blades 66′ on both sides, along which guide rollers 24′ move and that press guide rollers 24′ against the preload of the compression spring assigned to it toward the inside of circumferential contour of workpiece carrier 14′, 114′. These guide blades open outwardly in the direction of motion of workpiece carrier 14′, 114′ directly in front of or behind deflection device 16′, or outwardly opening guide blade sections 66a′, 66b′ are provided that enable guide rollers 24′ to move outwardly under the effect of the compression spring that exerts preload toward the outside of circumferential edge U of workpiece carrier 14′ 114′, so that they can enter into deflection engagement with the outer limiting surface of deflection strip 20′. Guide blade section 66b′ assigned to guide track 18′ then presses guide rollers 24′ back against the preload of the spring toward the inside of circumferential contour U of workpiece carrier 14′, 114′.

Due to the great similarity of 90° deflection strip 20′ for roller workpiece carrier 14′, 114′ according to FIG. 13 and 90° deflection strip 20 for pin workpiece carrier 14 according to FIG. 2a, it is understood that 180° deflection strips similar to deflection strip 30 according to FIGS. 4 and 5 and a switch function can also be realized for roller workpiece carriers 14′, 114′ in a similar manner by elastically bending one of the free ends 20a′ or 20b′ of deflection strip 20′, although this is not indicated in the drawings.

It will be understood that each of the elements described above, or two or more together, may also find a useful application in other types of constructions differing from the types described above.

While the invention has been illustrated and described as embodied in a conveyor system, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A conveyor system, comprising a conveyor track with a conveyor means that moves along at least one subsection of said conveyor track in a direction of conveyance; at least one workpiece carrier bringable into driving engagement with said conveying means to move it in the direction of conveyance; and a deflection device that deflects said workpiece carrier out of the direction of conveyance and therefore moves it from said subsection of said conveyor track, said deflection device including a deflection section that swivels said workpiece carrier around a swivel axis that is substantially parallel to its vertical axis, said deflection device also including a further deflection section that is located along a trajectory of said workpiece carrier in front of said deflection section and has a different design than said deflection section and that displaces said workpiece carrier laterally relative to said subsection of said conveyor track.

2. A conveyor system as defined in claim 1, wherein said deflection device also has a third deflection section located along the trajectory of said workpiece carrier after said deflection section and having a different design than said deflection section.

3. A conveyor system as defined in claim 2, wherein said third deflection section is configured so as to displace said workpiece carrier laterally relative to the subsection of a further conveyor track.

4. A conveyor system as defined in claim 1, wherein said deflection section has at least one undersection that is curved according a predetermined radius of curvature.

5. A conveyor system as defined in claim 2, wherein at least a section selected from the group consisting of said further deflection section, said third deflection section, and both includes at least one subsection with a radius of curvature which is greater than a radius of curvature of at least one subsection of said one deflection section.

6. A conveyor system as defined in 5, wherein a section selected from the group consisting of said further deflection section, said third deflection section, and both includes at least one further subsection having a radius of curvature which is smaller than a radius of curvature of said one subsection of said section selected from the group consisting of said further deflection section, said third deflection section, and both.

7. A conveyor system as defined in claim 6, wherein said further subsection is shorter than said subsection.

8. A conveyor system as defined in claim 6, wherein said further subsection of said section selected from the group consisting of said further deflection section, said third deflection section and both is located on an end of said one subsection of said one subsection of said section selected from the group consisting of said further deflection section, said third deflection section, and both opposite to said deflection section.

9. A conveyor system as defined in claim 2, wherein a section selected from the group consisting of said further deflection section, said third deflection section and both, extends substantially parallel to the direction of conveyance of a track selected from the group consisting of said conveyor track, a further conveyor track and both.

10. A conveyor system as defined in claim 2, wherein a section selected from the group consisting of said further deflection section, said third deflection section, and both has a free end forming a predetermined angle with a direction of conveyance of a track selected from the group consisting of said conveyor track, a further conveyor track, and both.

11. A conveyor system as defined in claim 2; and further comprising a deflection section extension which is deflectable in a resilient manner and located on a free end of said third deflection section.

12. A conveyor system as defined in claim 1, wherein said further deflection section has a free end which is displaceable in a direction extending substantially transversely to said subsection conveyor track.

13. A conveyor system as defined in claim 1, wherein said deflection device has a deflection strip that, on its side facing away from said workpiece carrier, is in deflection engagement with a guide unit of said workpiece carrier and in deflecting engagement with a guide surface of the workpiece carrier facing said workpiece carrier.

14. A conveyor system as defined in claim 13, wherein said guide unit includes just one guide element that is located on said workpiece carrier.

15. A conveyor system as defined in claim 13, wherein said one guide element of said guide unit is located on said workpiece carrier in a stationary manner.

16. A conveyor system as defined in claim 13, wherein said guide unit includes two guide elements having at least two degrees of freedom of movement relative to said workpiece carrier.

17. A conveyor system as defined claim 13, wherein said guide unit is located inside a peripheral contour of said workpiece carrier.

18. A conveyor system as defined in claim 13, wherein said guide unit is located adjacent to an edge of said workpiece carrier.

19. A conveyor system as defined in claim 13, wherein said guide surface and said one guide unit each is assigned to both edges of said workpiece carrier.

20. A conveyor system as defined in 13, wherein said guide surface or each of guide surfaces includes an orientation bevel on its end section of said workpiece carrier at a front relative to a direction of motion.

21. A conveyor system as defined in claim 20, wherein said guide surface or each of said guide surfaces includes an orientation bevel on its end surface of said workpiece carrier and on its rear end section.

22. A conveyor system as defined in claim 1, wherein said workpiece carrier has a rectangular base.

23. A conveyor system as defined in claim 22, wherein said rectangular base of said workpiece carrier has a ratio of a length of a shorter transverse side to a length of a large longitudinal side of a rectangle between substantially 1.2 and substantially 1.667.

24. A conveyor system as defined in claim 22, wherein said rectangular base has a ratio of a length of a shorter transverse side to a length of a longer longitudinal size substantially 1.23.

25. A conveyor system as defined in claim 1, wherein said deflection section has means for reducing a kinetic friction.

26. A conveyor system as defined in claim 1, wherein at least one of said deflection section, a further deflection section, said deflection device, and a guide surface of said workpiece carrier is provided with means for reducing a kinetic friction.

27. A conveyor system as defined in claim 14, wherein said guide element is provided with means for reducing a kinetic friction.
